(19) United States
(12) Patent Application Publication
(10) Pub. No.: US 2007/0189711 A1
(43) Pub. Date: Aug. 16, 2007

(54) Device and method for data exchange between content recording device and portable communication device

(76) Inventors: Noah B. Ash, Raleigh, NC (US); Paul H. Nichols, Raleigh, NC (US); Amanda L. Bazzell, Cary, NC (US); Tommy B. Stahlros, Cary, NC (US); Jean Chu, Raleigh, NC (US); John E. Ang, Raleigh, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/342,894

(22) Filed: Jan. 30, 2006

(51) Int. Cl. H04N 5/91

(52) U.S. Cl. 386/83

(57) ABSTRACT

A content recording device includes a wireless communication interface that is capable of communicating with a portable communication device. A portable communication device includes an application program for data exchange with and controlling a content recording device. The portable communication device is capable of controlling the content recording device, and is capable of receiving previously recorded content from the content recording device for playback on the portable communication device. The portable communication device and content recording device interact to provide a single mobile interface for the content recording device.

### TECHNICAL FIELD OF THE INVENTION

The present invention relates generally to portable communication devices, and, more particularly, to a portable communication device capable of data and content exchange with a content recording device.

### DESCRIPTION OF RELATED ART

In recent years, portable communication devices, such as mobile phones, personal digital assistants, mobile terminals, etc., continue to grow in popularity. As the popularity of portable communication devices continues to grow, today's wireless landscape is rapidly changing as mobile phones and networks are being enhanced to provide services beyond voice services. The wireless industry is experiencing a rapid expansion of mobile data services. The expansion of mobile data services is driven by continued technological advancement, as well as by the demand from users of portable communication devices. Portable communication devices are appealing to users because of their capability to serve as powerful communication and data service tools. With the increasingly busy lifestyles of many users of portable communication devices, users are placing a premium on making efficient use of time.

Likewise, in recent years, content recording devices, such as personal video recorders (PVRs), audio and digital recording devices and the like, are growing in popularity. Because of their flexibility, advanced capabilities and ease of use, PVRs are providing an alternative to VCRs as the primary means for recording television programs in the home. PVRs and other digital recording devices typically digitally record television content that is received via broadcast, cable or satellite.

PVRs typically employ powerful microprocessors to control the digital storage of content and other functionality. The sophisticated processing supported by PVRs and other like digital recording devices allows consumers to spend more time watching television or video programming that they like, and less time sorting through or watching television or video programming that they do not like.

While PVRs have radically altered the way consumers watch television, limitations still exist in that consumers cannot control the PVR and/or enjoy content recorded by the PVR when the user is away from the PVR.

### SUMMARY

In view of the foregoing, a need exists for additional mobile data services, and application programs for providing additional mobile data services, such as application programs that facilitate data exchange with and control of a content recording device. A further need exists for a content recording device that is capable of data exchange with and being controlled by a portable communication device.

One aspect of the invention relates to a content recording device that includes a tuner that receives a content program signal from a content provider, an encoder that encodes the content program signal into a first data format, a storage device that stores the encoded content program data, and transcoder circuitry operable to convert the encoded content program data into a second format suitable for transfer to and video playback on a portable communication device.

According to another aspect, the content recording device includes a communication interface operable to transfer the transcoded content program data to a portable communication device.

According to another aspect, the content recording device includes a device operable to prevent a copy of the content program data from being stored simultaneously on the content recording device and the portable communication device.

According to another aspect, the communication interface is a wireless communication interface.

According to another aspect, the wireless communication interface is a short-range radio frequency communication interface.

According to another aspect, the wireless communication interface is a Bluetooth communication interface.

According to another aspect, the wireless communication interface is a Global System for Mobile Communications (GSM) interface operable to communicate with a mobile telephone via a mobile network.

According to another aspect, the content recording device is a personal video recorder (PVR).

According to another aspect, the portable communication device is a mobile telephone.

According to another aspect, a communication system includes the content recording device as set forth above and a mobile telephone.

Another aspect of the invention relates to a program stored on a machine readable medium, the program being suitable for use in a portable communication device, wherein when the program is loaded in memory in the portable communication device and executed causes the portable communication device to receive program content data from a content recording device for playback on the portable communication device.

According to another aspect, the program causes the portable communication device to return the program content data to the content recording device.

According to another aspect, the program causes the portable communication device to receive an electronic program guide (EPG), display the EPG, and transmit a content selection command to the content recording device, the content selection command instructing the content recording device to record a selected content program.

According to another aspect, the program causes the portable communication device to transmit remote control signals to the content recording device.

According to another aspect, the content recording device is a personal video recorder (PVR), and the portable communication device is a mobile phone.

Another aspect of the invention relates to a portable communication device including a memory and a processor that executes an application program within the memory. The application program, when executed, causes the portable communication device to receive program content data from a content recording device for playback on the portable communication device and to display the program content data on a display of the portable communication device.

Another aspect of the invention relates to a method of remotely viewing a program recorded on a content recording device including converting the program data into a data format suitable for transfer to and video playback on a portable communication device, and transferring the converted program to a portable communication device for viewing.

According to another aspect, the content recording device is a personal video recorder (PVR), and the portable communication device is a mobile phone.

Another aspect of the invention relates to a method of remotely controlling a content recording device using a portable communication device including transmitting a content selection command to a content provider, the content provider directing the content recording device to record a selected program.

According to another aspect, the content selection command is transmitted via a mobile network.

Another aspect of the invention relates to a digital video recording device that includes a device operable to receive and store digital program data in a first format, and a device operable to convert the digital program data into a second format suitable for transfer to and video playback on a portable communication device.

According to another aspect, the digital recording device includes a device operable to transmit the converted digital program data to a portable communication device.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended thereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a diagrammatic illustration of a communication system including a portable communication device and a content recording device on which aspects of the present invention are carried out;

FIG. 2 is diagrammatic illustration of a content recording device in accordance with the present invention;

FIG. 3 is a diagrammatic illustration of a portable communication device in accordance with the present invention;

FIG. 4 is a flow chart or diagram representing the relevant operation of a content recording device in accordance with aspects of the present invention;

FIG. 5 is a flow chart or diagram representing the relevant operation of a portable communication device in accordance with aspects of the present invention; and

FIG. 6 is a diagrammatic illustration of a communication system including a portable communication device and a content recording device on which aspects of the present invention are carried out in accordance with an alternative embodiment.

### DETAILED DESCRIPTION OF EMBODIMENTS

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form.

As used herein, the term “content recording device” includes digital recording devices. The term “digital recording devices” includes digital audio recorders and digital video recorders, including, but not limited to, personal video recorders (PVRs), personal audio recorders and other devices capable of recording digital content or content in a format that can be manipulated or otherwise processed by a microprocessor.

In addition, as used herein, the term “portable communication device” includes portable radio communication equipment. The term “portable radio communication equipment”, which herein after is referred to as a mobile phone, a mobile device, a mobile radio terminal or a mobile terminal, includes all electronic equipment, including, but not limited to, mobile telephones, pagers, communicators, i.e., electronic organizers, smartphones, personal digital assistants (PDAs), or the like. While the present invention is being discussed with respect to portable communication devices, it is to be appreciated that the invention is not intended to be limited to portable communication devices, and can be applied to any type of electronic equipment capable of being used for voice and/or data communication.

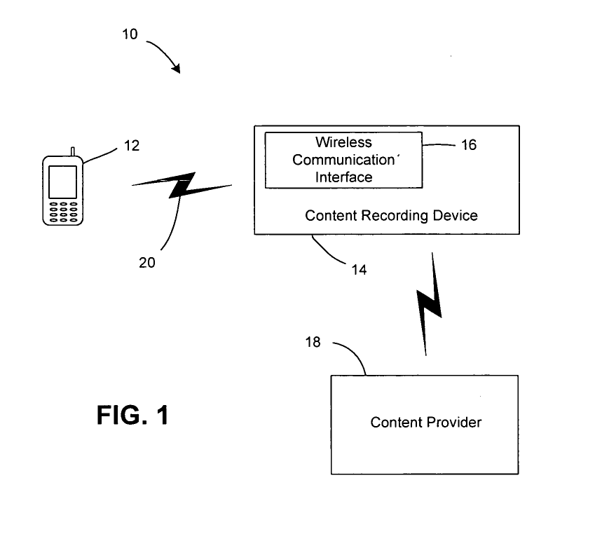

Referring initially to FIG. 1, a communication system 10 includes a portable communication device 12, such as a mobile phone, mobile terminal or the like and a content recording device 14, such as a personal video recorder (PVR) or the like. As is described more fully below, the content recording device 14 includes a wireless communication interface 16 that enables data exchange between the portable communication device 12 and the content recording device 14, as well as control of the content recording device 14 by or using the portable communication device 12. Alternatively, the portable communication device 12 is operable to exchange data with and/or control the content recording device 14 via a wired connection, e.g., the portable communication device being placed in a cradle in wired connection with the content recording device. As illustrated, the system 10 includes a content provider 18, e.g., a provider of audio content, video content and the like. As will be described, the portable communication device 12 and the content recording device 14 are operable to communicate and/or to exchange data via any suitable wireless medium 20.

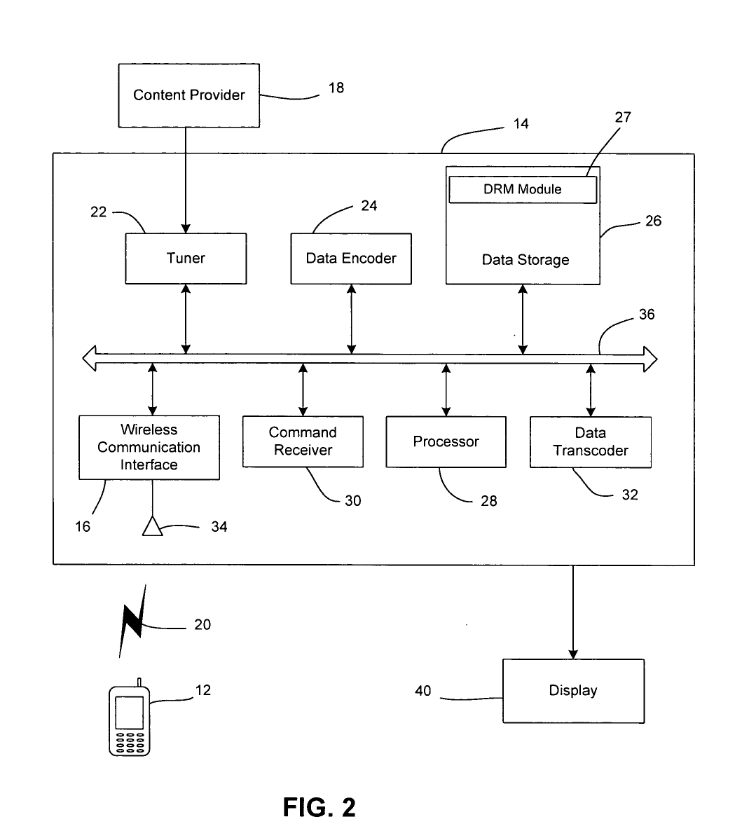

FIG. 2 represents a functional block diagram of a content recording device 14 in accordance with an exemplary embodiment of the present invention. As illustrated, the content recording device includes a tuner 22, a data encoder 24, a data storage device 26, including a digital rights management (DRM) module 27 stored therein, a processor 28, a command receiver 30, a data transcoder 32 and a wireless communication interface 16, for example, coupled to a suitable antenna 34. All of the above-mentioned components are coupled directly or indirectly to a bus 36 or another suitable linking device.

The content recording device 14, e.g., a personal video recorder (PVR), receives a source signal from a content provider 18, e.g., a satellite receiver, a cable provider, or another suitable provider of content (such as video programming). The processor 28 controls the overall operation of the content recording device 14. The processor 28 may be any commercially available or custom microprocessor or other device, e.g., other suitable electrical or electronic device, capable of carrying out the functionality of the content recording device.

Under control of the processor 28, the tuner 22 receives the content source signal and compresses it or otherwise suitably processes it using the data encoder 24. The data encoder 24 compresses or otherwise processes the received data signal in a suitable format, including, but not limited to MPEG, MPEG-2, MPEG-4, BV or the like. The encoded or otherwise compressed data files are stored in a data storage device 26, which may be any medium or media readable by the content recording device 14, such as any volatile or non-volatile mass storage device, such as a hard disc memory device or a random access memory (RAM). Skilled artisans will appreciate that the data storage device 26 may store many types of data, including content data, event data, index data, and/or machine-readable instructions. As is described more fully below, the content recording device includes a DRM module 27 to prevent multiple copies of a program from being provided for user viewing. This is also referred to herein as a “check in/check out” feature.

The content data may define a video file, encoded in a suitable format, containing a recording of the content contained or otherwise represented by the received content or program signal. Other types of video formats may be employed without departing from the scope of the present invention.

The content recording device 14 includes a wireless communication interface 16 coupled to an antenna 34 or other suitable signal receiving element. The wireless communication interface 16 can include any communication interface that is suitable for communicating with a portable communication device, such as a mobile phone, mobile terminal or the like. In one embodiment, the wireless communication interface 16 is a short-range radio frequency (RF) interface, such as a Bluetooth interface, which may use antenna 34. Bluetooth is a universal radio interface in the 2.45 GHz frequency band that enables portable electronic devices to connect and communicate wirelessly via short-range ad hoc network. One of ordinary skill in the art will understand the basic operations of a Bluetooth wireless communication interface, so the details will not be described here in detail for the sake of brevity.

While aspects of the present invention are being described with respect to a short-range RF interface, e.g., a Bluetooth interface, it is to be appreciated that the wireless communication interface can include any suitable communication interface, such as a GSM interface module capable of receiving short message service (SMS) communication, or other “over air” communication interfaces. It will be appreciated that with use of a GSM interface module or another “over air” module, a user would have access to his/her recorded programs and would be able to control the content recording device anywhere that mobile service is available. Further, the wireless communication interface may communicate via other suitable wireless media 20, short-range, e.g., infrared, radio frequency and the like. Those skilled in the art will appreciate that the content recording device 14 can include any suitable communication interface or any other network connectivity module without departing from the scope of the present invention.

As is described more fully below, the presence of a wireless communication interface 16 that is capable of communicating with a portable communication device 12 provides for a number of data exchange and/or control applications using the content recording device 14 and the portable communication device 12. The content recording device 14 includes command receiver circuitry 30 that is capable of receiving and processing user commands from the portable communication device 12, e.g., allowing the portable communication device to function as a remote controller.

A stored television or video program, e.g., one that has been recorded at a user's request using the portable communication device 12 as a remote controller, and user interfaces generated by processor 28 and other components of the content recording device 14 can be played back at user command via the portable communication device 12 on, for example, display 40. The display can be any suitable viewing device, such as a standard television or video monitor.

In accordance with a preferred embodiment, the content recording device 14 transfers recorded content, e.g., a stored television or video program, to the portable communication device 12 by way of the wireless communication interface 16 (or some other communication interface), such that the program is stored on the portable communication device 12 for later viewing or playback by the user. To accomplish this transfer of content to the portable communication device 12, the content recording device 14 includes data transcoder circuitry 32. The data transcoder circuitry 32, which is preferably implemented via application software within the content recording device, transcodes, decodes or otherwise converts the data format of the stored source signal (e.g., MPEG format or other suitable format) into a format that is suitable for video playback on the portable communication device (e.g., H.264 format or other suitable format).

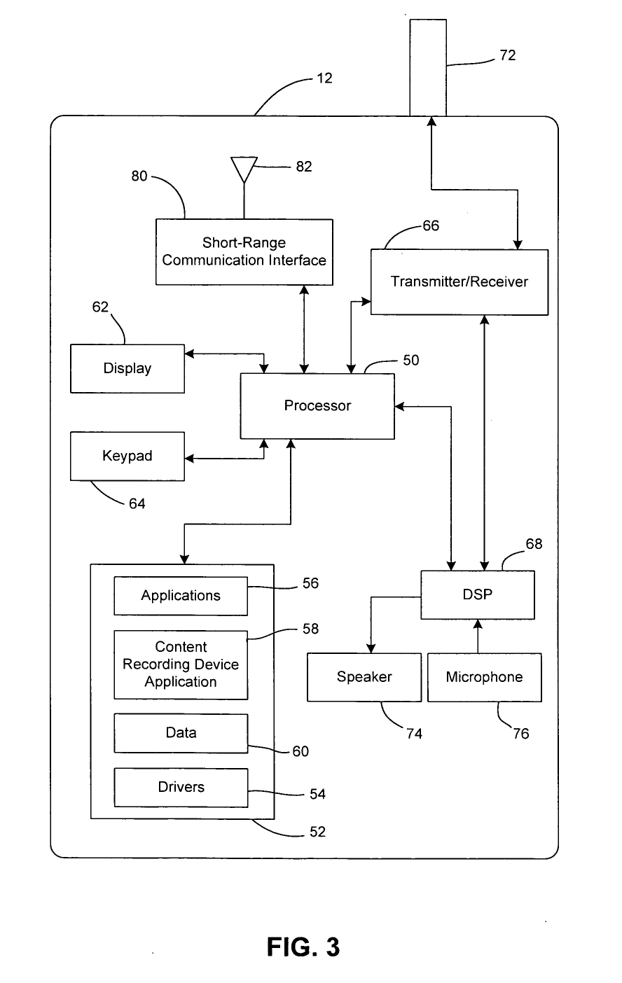

FIG. 3 represents a functional block diagram of a portable communication device 12 in accordance with the present invention. The portable communication device 12 includes a processor 50 for controlling the overall operation of the portable communication device 12. The processor 50 may be any commercially available or custom microprocessor or other suitable device. Memory 52 is operatively connected to the processor 50 for storing control programs and data used by the portable communication device. The memory 52 is representative of the overall hierarchy of memory devices containing software and data used to implement the functionality of the portable communication device in accordance with aspects of the present invention.

In the illustrated embodiment, memory 52 stores device drivers 54, e.g., I/O device drivers, application programs, indicated by reference numeral 56 generally, including a Content Recording Device (CRD) application program 58 in accordance with the present invention, and application program data 60, including content program data received from the content recording device. The I/O device drivers include software routines that are accessed through the processor 50 (or by an operating system stored in memory 52 (not shown)) by the application programs 56, including the CRD application program 58, to communicate with devices such as the display 52, other input/output ports and a content recording device.

The application programs 56, including the CRD application program 58, comprise programs that implement various features of the portable communication device 12, such as e-mail, Internet access, contact manager and the like. As is discussed more fully below, the CRD application program 58 comprises a program (or multiple programs) for controlling a content recording device 14 and for exchanging data, e.g., receiving pre-recorded video programs, for viewing or playback on the display 62 of the portable communication device 12.

A person having ordinary skill in the art of computer programming and in applications programming for mobile phones, in view of the description provided herein would be able to program a mobile phone to operate and carry out the functions described herein with respect to the Content Recording Device (CRD) application program 58. Accordingly, details as to the specific programming code have been omitted here for the sake of brevity. Also, while the control of and data exchange with a content recording device functionalities are carried out via the processor 50 and CRD application program 58 in memory 52 in accordance with aspects of the invention, such function could also be carried out via dedicated hardware, firmware, software or combinations thereof without departing from the scope of the present invention.

With continued reference to FIG. 3, the processor 50 interfaces with the display 62, a keypad 64, a transmitter/receiver 66 (often referred to as a transceiver), audio processing circuits, such as a digital signal processor (DSP) 68 (optional). The keypad 64 and display 62 provide a user interface that allows the user to interact with the portable communication device. Keypad 64 allows the user to dial numbers, enter commands and data, and select options. The display 62 allows the user to view a variety of information, such as dialed digits, stored information, and output from various applications, including the CRD application program 58.

An antenna 72 is coupled to the transmitter/receiver 66 such that the transmitter/receiver 66 transmits and receives signals via the antenna 72, as is conventional. The portable communication device 12 includes an audio processing circuit 68 for processing the audio signal transmitted by and received from the transmitter/receiver 66. Coupled to the audio processing circuit 68 are a speaker 74 and microphone 76, which enable a user to listen and speak via the portable communication device. The portable communication device also may include a separate communication interface 80, such as a short-range RF communication interface, e.g., a Bluetooth interface, coupled to an appropriate antenna 82 for communication with the corresponding communication interface in the content recording device.

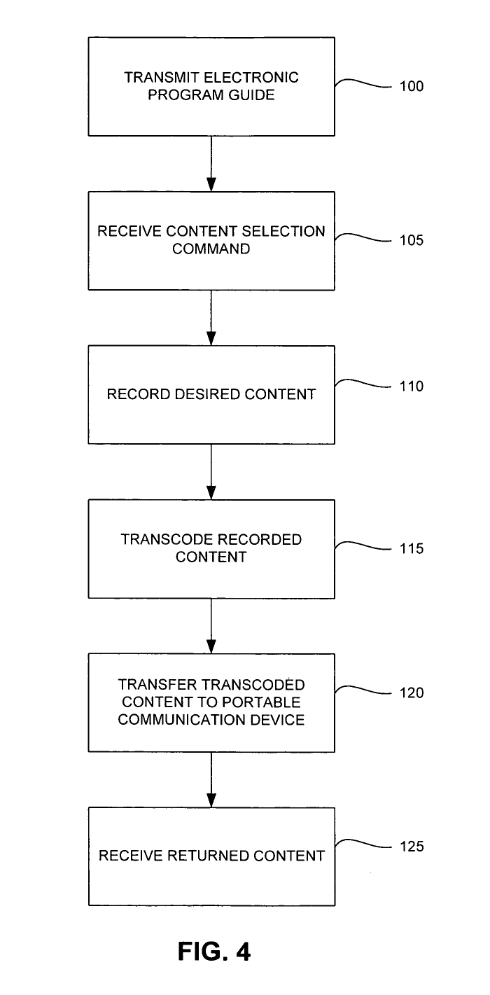

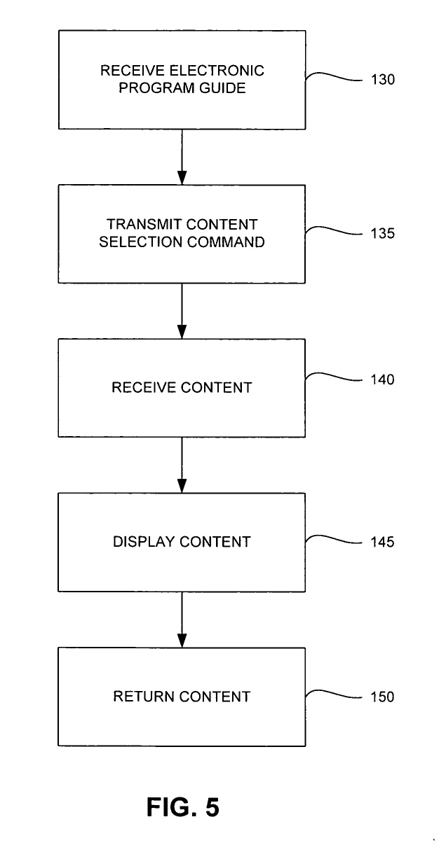

While, for purposes of simplicity of explanation, the flow charts or diagrams in FIG. 4 and FIG. 5 include a series of steps or functional blocks that represent one or more aspects of the relevant operation of the content recording device and portable communication device, respectively, it is to be understood and appreciated that aspects of the present invention are not limited to the order of steps or functional blocks, as some steps or functional blocks may, in accordance with the present invention, occur in different orders and/or concurrently with other steps or functional blocks from that shown and described herein. Moreover, not all illustrated steps or functional blocks of aspects of relevant operation may be required to implement a methodology in accordance with an aspect of the invention. Furthermore, additional steps or functional blocks of aspects of relevant operation may be added without departing from the scope of the present invention.

Turning now to FIG. 4, the relevant operation of the content recording device 14, including a method of data exchange between a content recording device 14 and a portable communication device 12, will be described from the perspective of the content recording device. As described above with respect to FIGS. 1-3, the content recording device 14 is equipped with a wireless communication interface 16 such that the content recording device 14 is capable of communicating or otherwise engaging in data exchange with the portable communication device 12. Conversely, the portable communication device 12 includes an appropriate application program and a communication interface such that it is capable communicating with or other otherwise engaging in data exchange with the content recording device 14. As discussed above, the invention is not limited to a particular type of communication interface. In fact, video program data may be transferred from the content recording device 14 to the portable communication device 12 via a wired connection without departing from the scope of the present invention.

At functional block 100, an electronic program guide (EPG) may be transmitted from the content recording device 14 to the portable communication device 12 using a suitable communication interface. The EPG is an application provided by content providers 18 to list current and scheduled programs that are available on each television channel. In one embodiment, the transfer of the EPG to the portable communication device is accomplished via short-range transmission, e.g., data syncing via Bluetooth when the user arrives at home. However, it is to be appreciated that the EPG can be transmitted to the portable communication device via any suitable communication medium without departing from the scope of the present invention. Typically, the content provider 18 transmits the EPG to the content recording device 14 for display to the user when the user is at home. By transmitting the EPG to the portable communication device 12, the user, through his/her portable communication device, can remotely browse and/or make programming selections, which will ultimately be transmitted to the content recording device.

At functional block 105, the content recording device receives a content selection command. The content selection command can be presented in a variety of ways, including, but not limited to, a user browsing the EPG on the portable communication device, and making a programming selection, as well as through conventional means, e.g., selecting a program when the user is at home.

After the content recording device receives a content selection command, the desired programming or other content is recorded at functional block 110 in a conventional manner. As described above, such content recording includes receiving a suitable content signal and encoding and storing the program in a suitable format, e.g., MPEG format.

In accordance with a preferred embodiment of the present invention, at functional blocks 115 and 120, the recorded content can be transferred from the content recording device 14 to the portable communication device 12 for later viewing or playback on the portable communication device 12. At functional block 115, the recorded content is transcoded, encoded or otherwise converted from the format stored on the content recording device, e.g., MPEG format, to a format that the portable communication device supports for video playback. In one exemplary embodiment, the conversion of the program data can be made from a MPEG format to a H.264 format. It is to be appreciated that the transcoding step 115 is not limited to any particular format type, either stored within the content recording device or on the portable communication device.

Once the recorded content has been transcoded at functional block 115, the transcoded content is transferred to the portable communication device at functional block 120. As described above, this transfer can be carried out using any suitable communication media. For example, the transfer can be carried out via short-range RF wireless transfer, e.g., Bluetooth, any other wireless transmission, and/or via a wired transmission (e.g., with the portable communication device placed within a cradle or other docking station that is connected to the content recording device). In one embodiment, the content recording device 14 includes a digital rights management (DRM) module 27 (also referred to herein as a check in/check out program) that provides security measures to comply with applicable DRM laws. For example, in order to avoid multiple copies of a given program being available for simultaneous viewing, the check in/check out functionality would allow a given program to be “checked out” from the content recording device and “checked in” to the portable communication device for viewing of the program by the user while the user is away from the content recording device, e.g., away from the home. This functionality allows a user to view a desired program at his/her leisure, for example, while commuting on a train, or during other “down time” throughout the day. In one accordance with one application, a user could “check out” a program, watch a portion of the program on the portable communication device, then “check in” the program to watch the remainder at home.

At functional block 125, once the user is finished viewing the desired program on the portable communication device, the user can return the content 125 to the content recording device. This can be thought of as checking in the previously checked out program. At this stage, the desired program can remain stored within the content recording device, or can be deleted, depending on the user's preference.

Turning now to FIG. 5, the relevant operation of the portable communication device, including a method of data exchange between a content recording device 14 and the portable communication device 12, will be described from the perspective of the portable communication device. At functional block 130, the EPG is received by the portable communication device from the content recording device. As described above, the EPG can be transmitted via any suitable communication medium without departing from the scope of the present invention. Once the EPG is received on the portable communication device, the content recording device (CRD) application program can process the EPG, thereby allowing the user to view program options and to make program selections while away from the content recording device.

At functional block 135, once the user makes one or more selections via the EPG on the user's portable communication device, a content selection command can be transmitted to the content recording device at functional block 135. As described above, transmission of the content selection command can be carried out using any suitable communication medium and any suitable communication interface between the content recording device and the portable communication device. In one embodiment, the user can view the EPG on his/her portable communication device while at home, and subsequently make a programming selection, such as would be done with a conventional remote control device. In this embodiment, the portable communication device, with the EPG downloaded thereon, serves as an in-house remote control. In accordance with one application, parents, who are upstairs, could control what their children are watching on a downstairs television.

At functional block 140, the portable communication device receives previously recorded content, e.g., video programming, from the content recording device. As described above, before receiving the previously recorded content, the content recording device will transcode or otherwise convert the video program data into a format that is suitable for storage within and display or playback on the portable communication device. At functional block 145, the user can display or otherwise playback the content on his/her portable communication device. Again, this allows the user to take previously recorded programming with him/her, rather than being tied to the home for viewing a recorded program.

At functional block 150, the user can return the content to the content recording device when he/she is finished viewing the content on his/her portable communication device. As described above, this can be carried out using the check in/check out feature on the content recording device.

Upon reading the foregoing, it will be appreciated that the functionality of the content recording device and portable communication device described herein provides the user with a single interface for a content recording device that the user can take with him/her wherever he/she goes.

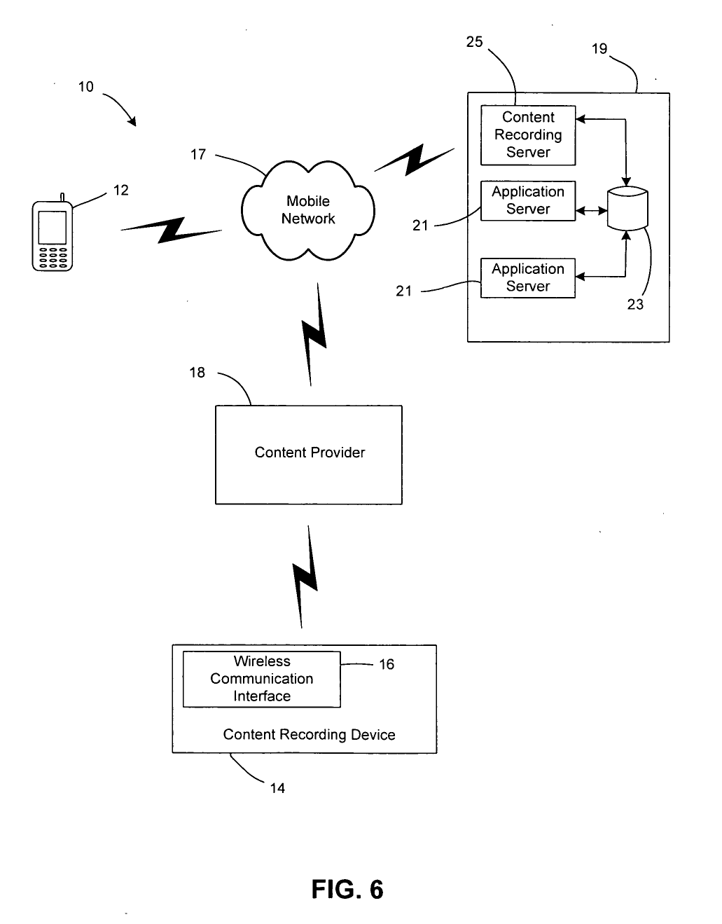

Turning now to FIG. 6, a communication system 10 is illustrated through which an alternative embodiment of the present invention may be carried out. In this embodiment, the portable communication device 12 can remotely control or otherwise select programs to be recorded on the content recording device 14 by providing appropriate command signals to the content provider 18.

The illustrated communication system 10 includes a mobile network 17, such as a mobile cellular telephony network that facilitates communication, such as voice communication and/or data transfer between a plurality of portable communication devices 12, such as mobile phones, mobile terminals and the like. The communication system 10 includes a network infrastructure 19, portions of which are used or otherwise accessed by the portable communication device in accordance with aspects of the invention. The portable communication device 12 may interact with other mobile devices and/or the network infrastructure in accordance with any suitable communication standard, including, but not limited to, Advanced Mobile Phone Service (AMPS), Digital Advanced Mobile Phone Service (D-AMPS), Global System for Mobile Communications (GSM), Code Division Multiple Access (CDMA) or the like. In other words, the communication system is shown in FIG. 6 for purposes of explaining aspects of the exemplary embodiment of the present invention, without limiting the invention to a particular communication system design, architecture or communication standard.

The network infrastructure 19 includes one or more application servers, which are indicated generally by the numeral 21, and a storage device 23, such as a memory for storing data accessible or otherwise usable by the application servers 21. At least one of the application servers is a content recording server 25. The application servers 21, including the content recording server 25, are computer servers that serve different functions in the communication system. As is described more fully below, the content recording server 25 is operable to provide information usable by the portable communication device 12 and/or the content recording device 14 to carry out a method of remotely controlling the content recording device using the portable communication device in accordance with aspects of the invention.

In this embodiment, the portable communication device allows the user to access an EPG for content schedule viewing and selection of desired programming to be recorded. The EPG can be downloaded onto the portable communication device and stored in the memory thereof. This aspect of the invention is not limited to a particular methodology for downloading an EPG onto the portable communication device. Once one or more programs are selected for recording, the portable communication device communicates with the content provider, either directly though the mobile network 17, or through the content recording server 25 within the network infrastructure 19. In this manner, the portable communication device 12 provides a content selection control signal to the content provider.

Upon receipt of the content selection control signal from the portable communication device 12, the content provider 18 communicates with the content recording device 14 (using conventional means already in place for communication with the content recording device) and commands the content recording device to record the programming selected by the user.

In accordance with another aspect of the invention, upon recording of a desired program, the content recording device 14 may transcode and transmit the recorded program to the portable communication device directly, via the mobile network, or indirectly with the recorded program being transferred to the content recording server 25 to be accessed by the portable communication device. In this embodiment, the user would have access to his/her recorded programs anywhere that mobile service is available.

As will be appreciated by one of skill in the art, computer program elements and/or circuitry elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A content recording device comprising:
a tuner that receives a content program signal from a content provider;
an encoder that encodes the content program signal into a first data format;
a storage device that stores the encoded content program data;
transcoder circuitry operable to convert the encoded content program data into a second format suitable for transfer to and video playback on a portable communication device.

2. The content recording device according to claim 1, further comprising:
a communication interface operable to transfer the transcoded content program data to a portable communication device.

3. The content recording device according to claim 1, further comprising:
a device operable to prevent a copy of the content program data from being stored simultaneously on the content recording device and the portable communication device.

4. The content recording device according to claim 2, wherein the communication interface is a wireless communication interface.

5. The content recording device according to claim 4, wherein the wireless communication interface is a short-range radio frequency communication interface.

6. The content recording device according to claim 4, wherein the wireless communication interface is a Bluetooth communication interface.

7. The content recording device according to claim 2, wherein the wireless communication interface is a Global System for Mobile Communications (GSM) interface operable to communicate with a mobile telephone via a mobile network.

8. The content recording device according to claim 2, wherein the content recording device is a personal video recorder (PVR).

9. The content recording device according to claim 2, wherein the portable communication device is a mobile telephone.

10. A communication system comprising the content recording device according to claim 2 and a mobile telephone.

11. A program stored on a machine readable medium, the program being suitable for use in a portable communication device, wherein when the program is loaded in memory in the portable communication device and executed causes the portable communication device to:
receive program content data from a content recording device for playback on the portable communication device.

12. The program according to claim 11, wherein the program causes the portable communication device to return the program content data to the content recording device.

13. The program according to claim 11, wherein the program causes the portable communication device to:
receive an electronic program guide (EPG);
display the EPG; and
transmit a content selection command to the content recording device, the content selection command instructing the content recording device to record a selected content program.

14. The program according to claim 11, wherein the program causes the portable communication device to transmit remote control signals to the content recording device.

15. The program according to claim 11, wherein the content recording device is a personal video recorder (PVR), and the portable communication device is a mobile phone.

16. A portable communication device comprising a memory and a processor that executes an application program according to claim 11 within the memory, wherein the application program causes the portable communication device to display the program content data on a display of the portable communication device.

17. A method of remotely viewing a program recorded on a content recording device, the method comprising:
converting the program data into a data format suitable for transfer to and video playback on a portable communication device; and
transferring the converted program to a portable communication device for viewing.

18. The method according to claim 17, wherein the content recording device is a personal video recorder (PVR), and the portable communication device is a mobile phone.

19. A method of remotely controlling a content recording device using a portable communication device, the method comprising:
transmitting a content selection command to a content provider, the content provider directing the content recording device to record a selected program.

20. The method according to claim 19, wherein the content selection command is transmitted via a mobile network.

21. A digital video recording device comprising:
a device operable to receive and store digital program data in a first format; and
a device operable to convert the digital program data into a second format suitable for transfer to and video playback on a portable communication device.

22. The digital recording device according to claim 21, further comprising:
a device operable to transmit the converted digital program data to a portable communication device.
